(19) United States
(12) Patent Application Publication
(10) Pub. No.: US 2004/0153381 A1
(43) Pub. Date: Aug. 5, 2004

(54) Real value accounting practice

(76) Inventor: Nicolaas Johannes Smith, Lisbon (PT)

Correspondence Address: Nicolaas Johannes Smith, Rua Raul Proenca, 30, Lisbon, 1400-366, PT

(21) Appl. No.: 10/758,189

(22) Filed: Jan. 16, 2004

Related U.S. Application Data
(60) Provisional application No. 60/440,643, filed on Jan. 17, 2003.

(51) Int. Cl. G06F 17/60

(52) U.S. Cl. 705/30

(57) ABSTRACT

This invention relates to the continuous daily computerized updating (increasing or decreasing, as the case may be) of all nonmonetary values in an accounting practice to continuously maintain all such values at constant real economic value over time when accounting an economic entity's economic activity in order to prevent Historical Cost Accounting inflation [the destruction of real economic value in nonmonetary values not updated (increased) over time in a cash inflationary economy], Historical Cost Accounting hyperinflation [the hyperdestruction of real economic value in nonmonetary values not updated (hyperincreased) over time in a cash hyperinflationary economy] and Historical Cost Accounting deflation [the creation of real economic value in nonmonetary values not updated (decreased) over time in a cash deflationary economy], as applicable, in all accounted nonmonetary values for an unlimited period of time.

### CROSS REFERENCE TO RELATED APPLICATION

Provisional Application No. 60/440,643

Filing Date Jan. 17, 2003

I wish to claim the benefit of Provisional Application No. 60/440,643 Filing Date Jan. 17, 2003. I wish to particularly point out and distinctly claim the subject matter which I regard as the invention as mentioned in the Provisional Application as mentioned above.

### BACKGROUND

The present invention generally relates to the field of automated business data processing technologies and more particularly to the continuous daily computer updating (increasing or decreasing, as the case may be) of all nonmonetary values in an accounting practice to continuously maintain all said nonmonetary values at daily constant real economic values over time when accounting an economic entity's economic activity to prevent Historical Cost Accounting inflation, Historical Cost Accounting hyperinflation and Historical Cost Accounting deflation, as applicable, in all the said nonmonetary values for an unlimited period of time.

It has always been accepted that inflation is a sustained rise in the general level of prices, that hyperinflation is a sustained hyperincrease in the general level of prices and that deflation is a sustained fall in the general level of prices.

This invention is based on a new analysis of the forms in which inflation, hyperinflation and deflation are manifested in our economies and makes a distinction between the one form being an economic process and the other form being the result of an accounting practice in each particular case.

Inflation manifests itself in two forms: in the form of Cash inflation and in the form of Historical Cost Accounting inflation. In both forms of inflation real economic value is destroyed continuously over time. Cash inflation is an economic process, which destroys real economic value in monetary values day by day over time, while Historical Cost Accounting inflation is the result of an accounting practice, which destroys real economic value in nonmonetary values day by day over time.

In an inflationary economy we have the following: 1.) Cash inflation which is always and everywhere the destruction of real economic value in depreciating money and depreciating monetary values over time as indicated by the change in the Consumer Price Index and 2.) Historical Cost Accounting inflation which is always and everywhere the destruction of real economic value in nonmonetary values not updated (increased) over time due to the use of the Historical Cost Accounting practice or any other accounting practice which does not permit the constant updating of all nonmonetary values in an economy subjected to cash inflation.

Hyperinflation manifests itself in two forms: in the form of Cash hyperinflation and in the form of Historical Cost Accounting hyperinflation. In both forms of hyperinflation real economic value is hyperdestroyed day by day over time. Cash hyperinflation is an economic process which hyperdestroys real economic value in monetary values over time and Historical Cost Accounting hyperinflation is the result of an accounting practice which hyperdestroys real economic value in nonmonetary values over time.

In a hyperinflationary economy we have the following: 3.) Cash hyperinflation which is always and everywhere the hyperdestruction of real economic value in hyperdepreciating money and hyperdepreciating monetary values over time as indicated by the change in the Consumer Price Index and 4.) Historical Cost Accounting hyperinflation which is always and everywhere the hyperdestruction of real economic value in nonmonetary values not updated (hyperincreased) over time due to the use of the Historical Cost Accounting practice or any other accounting practice which does not permit the constant updating (hyperincreasing) of all nonmonetary values in an economy subjected to hyperinflation.

Deflation manifests itself in two forms: in the form of Cash deflation and in the form of Historical Cost Accounting deflation. In both forms of deflation real economic value is created over time. Cash deflation is an economic process, which creates real economic value in monetary values day by day over time, and Historical Cost Accounting deflation is the result of an accounting practice, which creates real economic value in nonmonetary values day by day over time.

In a deflationary economy we have the following: 5.) Cash deflation which is always and everywhere the creation of real economic value in appreciating money and appreciating monetary values over time as indicated by the change in the Consumer Price Index and 6.) Historical Cost Accounting deflation which is always and everywhere the creation of real economic value in nonmonetary values not updated (decreased) over time due to the use of the Historical Cost Accounting practice or any other accounting practice which does not permit the constant updating (decreasing) of all nonmonetary values in an economy subjected to cash deflation.

The above is due to the fact that: A) In an inflationary economy where depreciating money is used as the depreciating monetary unit of account over time all monetary values have depreciating real economic values—as indicated by the change in the Consumer Price Index—as a result of the economic, political, monetary and social policies in that economy. These depreciating monetary values cannot now be physically updated over time, firstly, as a result of the fact that depreciating bank notes and depreciating bank coins have their fixed nominal values permanently printed or moulded onto them and, secondly, as a result of the fact that depreciating accounted monetary values have the same attributes as depreciating money with the single exception that they are not physical depreciating notes and physical depreciating coins, but depreciating accounted monetary values; and all nonmonetary values have constant real economic values over time but are accounted also using depreciating money as the depreciating monetary unit of account with the result that these constant nonmonetary real values have to be updated (increased) over time at the rate of cash inflation to reflect the decrease in the real value of the depreciating monetary unit of account since, over each and every period of time, the real price of a nonmonetary real value changes inversely with the change in the real value of depreciating money when all else are equal except the value of depreciating money.

B) In a hyperinflationary economy where hyperdepreciating money is used as the hyperdepreciating monetary unit of account over time all monetary values have hyperdepreciating real economic values—as indicated by the hyperchange in the Consumer Price Index—as a result of the economic, political, monetary and social policies in that economy. These hyperdepreciating monetary values cannot now be physically updated over time, firstly, as a result of the fact that hyperdepreciating bank notes and hyperdepreciating bank coins have their fixed nominal values permanently printed or molded onto them and, secondly, as a result of the fact that hyperdepreciating monetary values have the same attributes as hyperdepreciating money with the single exception that they are not physical hyperdepreciating notes and physical hyperdepreciating coins, but accounted hyperdepreciating monetary values; and all nonmonetary values have constant real economic values over time but are accounted also using hyperdepreciating money as the hyperdepreciating monetary unit of account with the result that these constant nonmonetary real values have to be updated (hyperincreased) over time at the rate of cash hyperinflation to reflect the hyperdecrease in the real value of the hyperdepreciating monetary unit of account since, over each and every period of time, the real price of a nonmonetary real value changes inversely with the change in the real value of hyperdepreciating money when all else are equal except the value of hyperdepreciating money.

C) In a deflationary economy where appreciating money is used as the appreciating monetary unit of account over time all monetary values have appreciating real economic values—as indicated by the change in the Consumer Price Index—as a result of the economic, political, monetary and social policies in that economy. These appreciating monetary values cannot now be physically updated over time, firstly, as a result of the fact that appreciating bank notes and appreciating bank coins have their fixed nominal values permanently printed or molded onto them and, secondly, as a result of the fact that appreciating accounted monetary values have the same attributes as appreciating money with the single exception that they are not physical appreciating notes and physical appreciating coins, but appreciating accounted monetary values; and all nonmonetary values have constant real economic values over time but are accounted also using appreciating money as the appreciating monetary unit of account with the result that these constant nonmonetary real values have to be updated (decreased) over time at the rate of cash deflation to reflect the increase in the real value of the appreciating monetary unit of account since, over each and every period of time, the real price of a nonmonetary real value changes inversely with the change in the real value of appreciating money when all else are equal except the value of appreciating money.

It is generally accepted and well known that cash inflation destroys real value in depreciating money and depreciating monetary values, that cash hyperinflation hyperdestroys real value in hyperdepreciating money and hyperdepreciating monetary values and that cash deflation creates real value in appreciating money and appreciating monetary values over time.

The destruction and hyperdestruction of real value in nonmonetary values by Historical Cost Accounting inflation and Historical Cost Accounting hyperinflation, respectively, and the creation of real value in nonmonetary values by Historical Cost Accounting deflation are further explained as follows:

A nonmonetary value has a constant real value over time. When it is never updated (increased) over time, when an economic entity uses Historical Cost Accounting in an inflationary economy or hyperinflationary economy, it in reality takes on an attribute of a monetary value, i.e., a fixed nominal historical cost value subjected to the same well known destruction or hyperdestruction of real value over time as in all monetary values.

When using Historical Cost Accounting in an inflationary or hyperinflationary economy, the profit from a business transaction accounted in a financial year can be maintained in the business process of an economic entity during that financial year. If it is not maintained then real value equal to the rate of inflation or hyperinflation, as applicable, times the profit real nonmonetary value is destroyed by Historical Cost Accounting inflation or Historical Cost Accounting Hyperinflation, as the case may be, for the total period during that financial year that the profit value is not maintained in the business process.

Real value is not destroyed, in an inflationary or hyperinflationary economy, in some nonmonetary values, e.g. fixed assets, just because their values are not updated at a point in time. These are “live” nonmonetary values since they can be updated in the market when they are exchanged between economic entities at arms length after the elapse of time which can be many financial periods later.

Modified Historical Cost Accounting allows an economic entity to update the real value of fixed assets in low cash inflationary economies and cash hyperinflationary economies and to add this Revaluation Reserve to paid up share capital. It is clear that only an economic entity with 100 percent of its paid up share capital invested in fixed assets can achieve 100 percent capital maintenance in this way. Very few economic entities have 100 percent of their capital invested in fixed assets. This invention permits all nonmonetary real values, including 100 percent of paid up share capital, to be constantly updated for an unlimited period of time.

An economic entity's paid up share capital is a nonmonetary value, which is generally not maintained at its real value over time in inflationary and hyperinflationary economies when an economic entity uses Historical Cost Accounting. An economic entity's paid up share capital is partly eroded and partly destroyed by Historical Cost Accounting inflation or Historical Cost Accounting hyperinflation as the case may be. Via the overstatement of Historical Cost profits a portion of the capital value is passed along to taxes and dividends. This is the erosion of the real value of paid up share capital. This only happens when the overstated Historical Cost profit is fully maintained over the period of the financial year in the business process of an economic entity. When the overstated profit is not fully maintained via the economic entity's business process over the period of the financial year, a portion of the paid up share capital nonmonetary real value is not passed on to dividends and taxes but is actually destroyed by Historical Cost Accounting inflation or Historical Cost Accounting hyperinflation, as applicable. This is the destruction of paid up share capital by Historical Cost Accounting inflation and Historical Cost Accounting hyperinflation.

A portion of the eroded paid up share capital passed along to dividends and taxes is then destroyed by Historical Cost Accounting inflation and Historical Cost Accounting hyperinflation when the dividends and taxes are not updated over time by the recipients of the dividends and taxes, i.e. shareholders and government.

A debtor gains value and a creditor loses value over time in an inflationary economy and hyperinflationary economy where Historical Cost Accounting is used. This is only true when the real nonmonetary values in both economic entities'—who are party to the deal—accounts are fully maintained via the economic entities' business processes. Real value is destroyed by Historical Cost Accounting inflation and Historical Cost Accounting hyperinflation when this does not happen at a 100 percent rate and economic activity contracts in both economic entities' activities.

In a deflationary economy a nonmonetary value also has a constant real value over time. When it is never updated (decreased) over time in an deflationary economy it in reality takes on an attribute of a monetary value in a deflationary economy, i.e., a fixed nominal historical cost value subjected to the same well known creation of real value over time as in all monetary values in a deflationary economy.

Value is created in all nonmonetary values not updated (decreased) over time in a deflationary economy when Historical Cost Accounting is used by an economic entity.

It is well known that a high rate of cash inflation, any rate of cash hyperinflation as well as any rate of cash deflation are all undesirable economic processes. Likewise, the destruction of real nonmonetary value by Historical Cost Accounting inflation and Historical Cost Accounting hyperinflation as well as the creation of real nonmonetary value by Historical Cost Accounting deflation are undesirable losses and profits resulting from the use by an economic entity of Historical Cost Accounting or any other accounting practice which does not permit the continuous updating (increasing or decreasing, as the case may be) of all real nonmonetary values over time in an inflationary, a hyperinflationary and a deflationary economy, as applicable.

Historical Cost Accounting inflation, Historical Cost Accounting hyperinflation and Historical Cost Accounting deflation cause economic distortions in an economic entity's economic activity, which can have very negative economic, social and political results. This invention eliminates the economic distortions caused by Historical Cost Accounting inflation, Historical Cost Accounting hyperinflation and Historical Cost Accounting deflation, as applicable.

All the above are subject to the normal accounting treatment of the following values:

Current quoted investments are valued at market value.

Fixed assets are updated and reduced to recoverable value where applicable.

Stock is updated and reduced to net realisable value where applicable.

### BRIEF SUMMARY

A novel feature of this invention is that it provides an economic entity with a computerized accounting practice which includes the steps for continuously updating all nonmonetary real economic values to keep them at their constant real economic values on a daily basis for an unlimited period of time under all possible economic environments—including cash inflation, cash hyperinflation and cash deflation—to prevent the destruction of real economic value in nonmonetary values by Historical Cost Accounting inflation in an inflationary economy, the hyperdestruction of real economic value in nonmonetary values by Historical Cost Accounting hyperinflation in a hyperinflationary economy and the creation of real economic value in nonmonetary values by Historical Cost Accounting deflation in a deflationary economy, as applicable.

A novel feature of his invention is that it provides an economic entity with organized accounts with a computerized accounting practice which includes the steps for accounting the net monetary loss or gain from monetary holdings under all possible economic environments—including cash inflation, cash hyperinflation and cash deflation. This permits an economic entity with organized accounts to account the cost of cash inflation and the cost of cash hyperinflation as losses and the gain from cash deflation as a profit.

A novel feature of this invention is that all nonmonetary values representing an economic entity's nonmonetary assets, nonmonetary liabilities, nonmonetary income or nonmonetary expenses are displayed, printed, internally processed or electronically transferred to any destination inside or outside any computer, device, system or network on which the invention is implemented, at any time only at real updated current values after the elapse of time—never at historical cost.

Because of the current difficulty of producing real time final financial statements an exception is only made for work on the completion of periodic reports of the financial position of an economic entity as at a specific date, for example month-end, quarter-end, six monthly accounts and year-end financial statements. When this work is done after the closing date, then values only for the purpose of the closing reports, are run at the closing date rate. These closing reports are finalised at the closing date rate, but always presented after that date only with all monetary and nonmonetary values updated to the current date rate.

A feature of this invention is that the real economic value of a monetary value balance is updated to the current rate when it is presented at the current date only for comparison purposes. This applies to prior period monetary values, budgeted monetary values prepared at prior dates and forecasts of future real values of monetary values at forecasted future levels of the CPI.

Monetary values in actual nominal value notes, actual nominal value coins and nominal value monetary ledger balances in actual monetary value ledger accounts are not updated as they are nominal values and it is now impossible to update a nominal value printed on a bank note or moulded onto a bank coin. Accounted nominal value monetary ledger balances have all the attributes of nominal value notes or nominal value coins with the single exception that they are accounted nominal monetary ledger values and not physical nominal value notes and physical nominal value coins.

Additional objects, advantages and novel features of the invention will become more apparent to those skilled in the art upon examination of the invention or may be learned by practice of the invention.

### BRIEF DESCRIPTION OF THE DRAWINGS

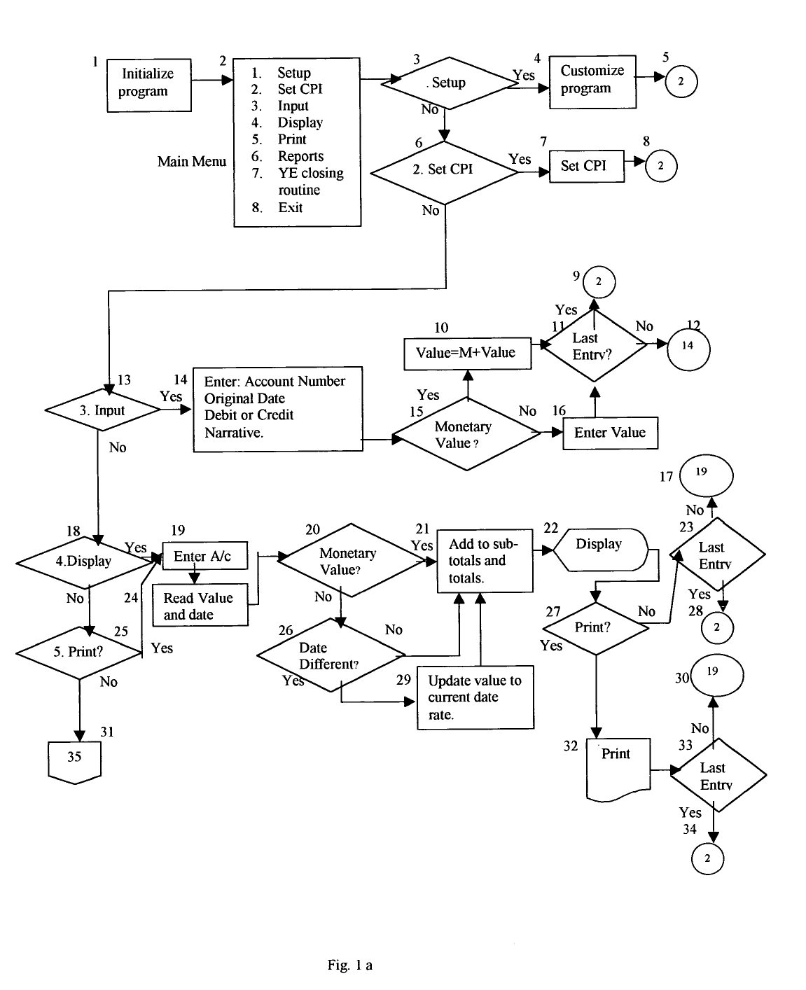

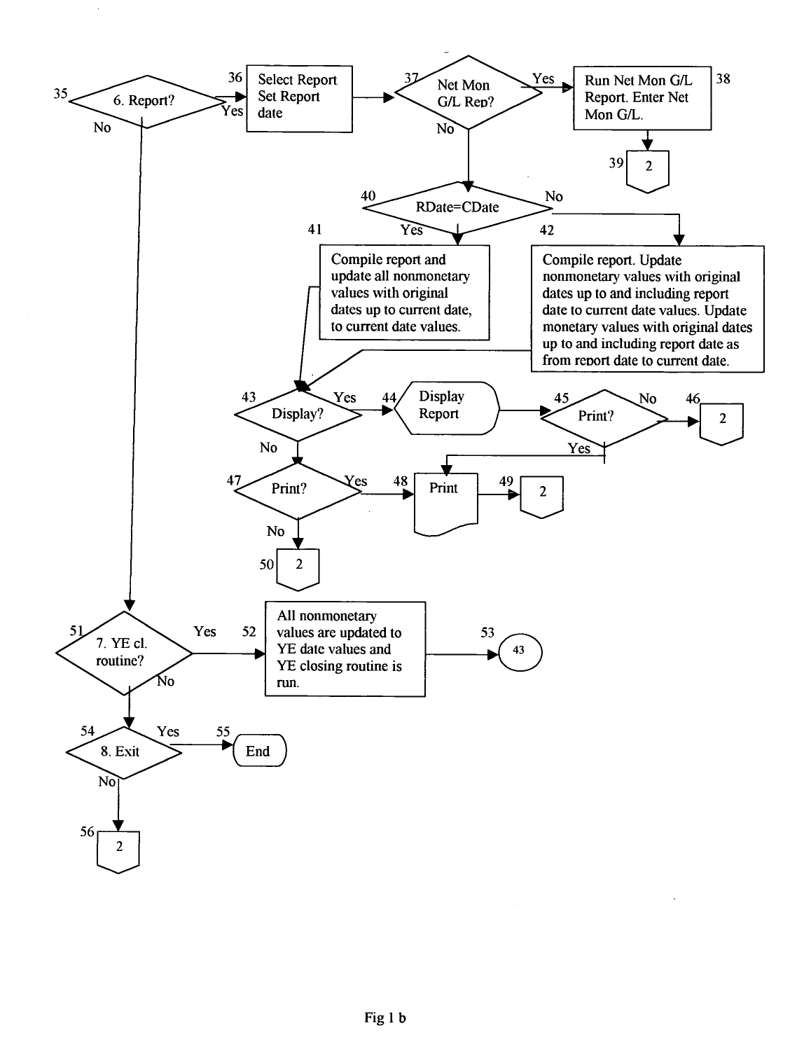

A full understanding of the invention can be gained from the following detailed description when read in conjunction with all the information in the abstract, the field of the invention, the background and the summary of the invention as well as the accompanying drawings in which FIG. 1a and FIG. 1b are flow charts showing the method and system of the invention.

### DETAILED DESCRIPTION OF THE INVENTION

Real value is based on all the underlying value systems in an economy, including but not limited to the economic system, the monetary system, the political system, the social system, the educational system, the defense system, the health system, the security system, the legal system, the justice system, the accounting system, etc, to name but a few.

This invention provides an economic entity with a computerized accounting practice which includes the steps for updating all nonmonetary real economic values daily to continuously maintain them at their constant real economic values for an unlimited period of time under all possible economic environments—including cash inflation, cash hyperinflation and cash deflation—to prevent the destruction of real economic value in nonmonetary values by Historical Cost Accounting inflation in an inflationary economy, the hyperdestruction of real economic value in nonmonetary values by Historical Cost Accounting hyperinflation in a hyperinflationary economy and the creation of real economic value in nonmonetary values by Historical Cost Accounting deflation in a deflationary economy, as applicable.

In an embodiment of the invention a newly incorporated economic entity uses the accounting software, which includes steps for daily updating all nonmonetary values, to account all its economic activities from the first day of its incorporation, 1^{st} Feb. 2003, in a cash inflationary economy.

The economic entity has to indicate to all other economic entities which it has dealings with, that it uses this invention as from 1^{st} Feb. 2003 and that all its economic dealings will as from that date constantly be conducted only at daily real updated current values for all nonmonetary values in order to prevent the destruction of real economic value by accounting inflation while the economy is in a cash inflationary mode. This has to appear on all its documents, websites, financial statements, invoices, credit notes, debit notes, receipts, etc. It has to state that it is contstantly accounting all its economic activities daily using this invention and that all nonmonetary values will be daily updated over time at the rate of change in the CPI over the time period in question. It has to state that the acceptance of its invoice, credit note, debit note or whatever other document of sale or other document that represents an invoice, a credit note or debit note or any contract, by the buyer of its products, services or rights, implies acceptance of and agreement to this fact. It also has to state that it will daily account its suppliers' invoices, credit notes, debit notes or whatever other documents of sale or other documents that represent invoices, credit notes or debit notes or any contract continuously based on this invention.

FIG. 1a and FIG. 1b show flow charts that illustrate the invention. Referring in particular to FIG. 1a, in box 1, the program is initialized. In box 2, the main menu, the Setup option is selected. The program passes to decision diamond 3 where the program is directed to box 4 where the software is customized to the economic entity's specific requirements. At connector 5 the program passes to the main menu at box 2.

The Set CPI option is chosen in box 2 to set the latest value of the Consumer Price Index.

This invention relates to the daily computer updating of all nonmonetary values to prevent accounting inflation, accounting hyperinflation and accounting deflation, as applicable. The change in the local CPI is determined by the change in the real value of the local monetary unit of account over time in the local economy. The software is preprogrammed with the level for the CPI for the local economy being that CPI related to the currency in which the economic entity conducts its economic activities and which it uses as its monetary unit of account to account its economic affairs. The number of years of past data for the CPI to be preloaded is determined by the time period that an economic entity estimates that it will need the preloaded data for.

In a cash hyperinflationary economy the level of the CPI changes daily by up to 5 percent or more, but it is not officially available till a month and a half or two months later. What is used to update nonmonetary values on a daily basis is the exchange rate of a relatively stable foreign currency. This is almost always the depreciating US Dollar exchange rate. It can also be the relatively stable depreciating Euro or any other relatively stable depreciating foreign currency. There are normally at least two depreciating US Dollar exchange rates being used in a cash hyperinflationary economy. The one is the official depreciating US Dollar exchange rate published by the Central Bank or a government agency. It is not to be used with this invention in a cash hyperinflationary economy as it is normally not the real exchange rate of the depreciating US Dollar in a cash hyperinflationary economy. The one to be used is the street rate or black market rate that is determined in the streets by confirming the daily black market rate in various markets in the capital city. You have to communicate by mobile radio or mobile phone with traders in the various markets to determine the street rate for the day. There is normally only one daily rate used throughout the capital city or region. This is the correct real exchange rate of the depreciating US Dollar to be entered on a daily basis with this invention in a cash hyperinflationary economy. The hyperdepreciating local currency in a hyperinflationary economy is normally only used as a hyperdepreciating national unit of exchange. It has almost no store of hyperdepreciating value function (it only has a daily store of value function).

As soon as the cash hyperinflationary economy passes into a low cash inflationary economy mode, the CPI can be used instead of the depreciating US Dollar exchange rate for updating nonmonetary values with the necessary adjustments made.

In a low cash inflation or low cash deflation economy the latest level of the CPI is normally only available a month and a few days after the month to which it relates. The level to be entered is the latest level available. Year-end final accounts are run at the correct CPI level when it becomes available. The daily level of the CPI is calculated by assuming that the change in the CPI occurs evenly over the time period for which the change in the CPI is made available. This calculation is preprogrammed. All that is required is to enter the latest change (or actual level of the CPI, as applicable) in the CPI as soon as it is officially available.

The program proceeds to decision diamond 6 where it is directed to box 7 where the latest available change in the level of the CPI is entered. The monthly change of, for example, 1 percent is entered on 28^{th} Feb. 2003. The CPI can be set either at the actual level or as the change in the level of the CPI. At connector 8 the program returns to the main menu at box 2.

The Input option is chosen to load the opening account balances. The program passes to decision diamond 13 where the program is directed to box 14.

All the entity's economic activity is accounted based on the seven fundamental accounting principles:

1. Substance over form

2. The system of double entry

3. The accruals principle

4. The matching principle

5. The prudence principle

6. The going concern principle

7. The consistency principle

The real value accounting practice is based on the Real Value Principle: The original nominal value of a real value item is to be continuously updated (increased, hyperincreased or decreased) based on the movement in the Consumer Price Index when the monetary unit of measure is depreciating, hyperdepreciating or appreciating money in a cash inflationary, cash hyperinflationary or cash deflationary economy, as applicable.

Monetary values are depreciating money and depreciating monetary values, hyperdepreciating money and hyperdepreciating monetary values and apprecaiting money and appreciating monetary values, as applicable. Examples of depreciating or appreciating monetary values are bank notes and bank coins, demand deposit bank balances, the capital amounts of all bank or other money loans made to an economic entity or received from an economic entity whether an entity (the bank, for example) pays or receives interest or not.

All other values are nonmonetary values and include all other balance sheet nonmonetary assets and nonmonetary liabilities and all values in the profit and loss account. Nonmonetary values include paid up share capital, profits, losses, taxes, rent, interest, salaries, wages, retained profits, retained losses, shareholders' interest, etc.

A real nonmonetary value, for example a debtor's (receivable's) value for a sale of goods, services or rights always paid in depreciating or appreciating money is not a depreciating or appreciating monetary value just because it is always paid in the form of depreciating or appreciating money. Depreciating or appreciating money is only the agreed upon depreciating or appreciating medium of exchange for that constant real nonmonetary value. It is always a nonmonetary value (it has to be updated over time) up to the moment of the payment of the nonmonetary value in depreciating or appreciating money. After the payment in depreciating or appreciating money it is not a nonmonetary debt (receivable) any more. It is then a depreciating or appreciating monetary value, which can be kept in that nominal unupdatable form or it can be exchanged for a new nonmonetary value to be updated over time.

When the new economic entity is started with fully paid up share capital of 1000000 of the entity's national currency, the first input entry is the account number of the Share Capital Account. The original date is the entity's date of incorporation—1^{st} Feb. 2003—when the share capital is paid up on that day. Share capital is a credit value and a narrative is entered. The program then passes to decision diamond 15 where No is selected since share capital is a nonmonetary value and the program proceeds to box 16 where the nonmonetary value is entered at its original value on the original date, namely 1000000 of the depreciating national currency. The program then passes to decision diamond 11 where No is selected since it is not the last entry. The program passes via connector 12 to box 14 where the Bank Account code in the entity's chart of accounts is entered. The original date is the entity's date of incorporation when the share capital is paid up and deposited in the bank and available on that day. The bank deposit is a debit and a narrative is entered. The program then passes to decision diamond 15 where Yes is selected since the bank deposit is a monetary value. The program then passes to box 10 where the monetary value is entered and the program adds the alphabetic letter M to the monetary value and it is saved as an alphanumeric value. The program then passes to decision diamond 11 where Yes is selected to indicate that it is the last entry for the loading of the opening balances. The program proceeds via connector 9 to the main menu a box 2.

When on the 1^{st} Feb. 2003 the economic entity used the money to buy stock for resale the Input option is selected in box 2 to record this transaction. The program proceeds to decision diamond 13 where it is directed to box 14. The Stock Account code is entered and 1^{st} Feb. 2003 as the original date of the stock purchase. Stock is a debit and a narrative is entered. The program passes to decision diamond 15 where No is selected since stock is not a monetary value. The original value of stock purchased is entered as 1000000 units of depreciating local currency. The program proceeds to decision diamond 11 where No is selected since it is not the last entry and the program passes via connector 12 to box 14. The Bank Account code is entered since all the money was used to pay for the stock purchased. The original date is again entered as 1^{st} Feb. 2003, the withdrawal of the cash to make the payment is a credit in the Bank Account and a narrative is entered. The program passes to decision diamond 15 where Yes is selected and the program passes to box 10 where an M is added to the value. The program then passes via decision diamond 11 and connector 9 back to the main menu at box 2.

When the economic entity operates in a cash inflationary economy and was incorporated on 1^{st} Feb., 2003 and the monthly cash inflation rate is 1 percent on 28^{th} Feb., 2003 and all the stock is still unsold on 28^{th} Feb. 2003, then the entity account balances are displayed as follows on the 28^{th} Feb., 2003:

The Display option is selected in the main menu in box 2. The program proceeds to decision diamond 18 where it is directed to box 19. The Share Capital account number is entered. The program is directed to box 24 where it reads the first value and the date of that value in the Share Capital Account. Every value is always read with its date. The program proceeds to decision diamond 20 where the program determines whether the value read is a monetary value by verifying whether an alphabetic letter M is added with the value in an alphanumeric value. Share Capital is not a monetary value and the program proceeds to decision diamond 26 where the program determines whether the value's original date is different from the current date. The original date is different since the current date is 28th Feb. 2003 and the original date of the Share Capital value is 1^{st} Feb. 2003. The program proceeds to box 29 where the share capital value is updated to the current date value. This is done programmatically by updating (increasing) the value of the share capital at the rate of cash inflation over the period as from the original date of the value to the current date rate. The program then passes to box 21 where the updated value is added to the previous total which was zero. The program proceeds to display 22 and the Share Capital value is displayed at the current date 28^{th} Feb. 2003 as 1010000 in the depreciating local currency. The program then passes to decision diamond 27 where No is selected and the program proceeds to decision diamond 23 where No is selected. The program passes via connector 17 to box 19 where the Stock Account number is entered. The program proceeds to box 24 where the first value and date is read. The program proceeds to decision diamond 20 where the program determines whether the value read is a monetary value by verifying whether an alphabetic letter M is added with the value in an alphanumeric value. The program finds no M attached to the stock value, which indicates to the program that it is a nonmonetary value. The program then passes to decision diamond 26 and the program finds that the stock value's original date is different from the current date. The program passes to box 29 where the stock value is updated for the 1 percent cash inflation for the month. The program then proceeds to box 21 where the value is added to the total value which was zero before. The program then passes to display 22 where the stock value is displayed as 1010000 of the depreciating local currency. The program then proceeds via decision diamonds 27 and and 23 and connector 28 back to the main menu at box 2 since the Bank Account balance is zero.

The Print option is selected. The logic is the same as for the Display option with the only difference that instead of being displayed the values are printed.

All economic events and transactions by the economic entity are entered via the Input option in box 2. All values are entered at their original dates and values. All values are entered as either monetary or nonmonetary values. All monetary values are displayed and printed at their nominal original values when actual monetary ledger account balances (eg. Bank Account) or actual monetary values are requested for current financial period purposes.

Reports are selected as option 6 Reports in box 2, the main menu. The report can be a trial balance, a list of debtors' balances, creditors' balances, suppliers' balances, sales, stock values, Income Statement, Balance Sheet, Net Monetary Loss or Gain Report, Bank account balances, etc.

In FIG. 1b the program passes to decision diamond 35 where it is directed to box 36 where the report is selected and the report date is set. The program proceeds to decision diamond 37 where Yes is selected to indicate that the Net Monetary Gain or Loss report is required. The program passes to box 38 where the Net Monetary Gain or Loss report is run at the year-end date before the YE Closing routine is run. The Net Monetary Gain or Loss report date is selected at the period-end date and all nonmonetary values are updated to the period-end date. A trial balance is run of all assets, liabilities, income accounts and expense accounts, i.e. of all accounts. Monetary accounts are not updated and the difference in the trial balance is the Net Monetary Gain or Loss for the period. This will be the same as the change in the Consumer Price Index over the financial period times the weighted average for the period of the difference between monetary assets and monetary liabilities.

When an economic entity had an excess of monetary assets over monetary liabilities it will have a Net Monetary Loss and when it had and excess of monetary liabilities over monetary assets it will have a Net Monetary Gain in an inflationary and a hyperinflationary economy and vice versa in a deflationary economy. The Net Monetary Gain or Loss is determined and a one-sided journal entry is entered to record the Net Monetary Gain or Loss which becomes a nonmonetary value the moment it is accounted and has to be updated over time. The program then passes back to the main menu at box 2 via off-page connector 39.

When another report is selected the program passes from decision diamond 37 where No is selected to decision diamond 40 where the program determines whether the report date requested is the same as the current date. When the answer is Yes the program passes to box 41 where the report is compiled and all nonmonetary values with original dates up to the current date are updated to the current date.

When the program at decision diamond 40 determines that the report date requested is not the same as the current date (i.e. it is a past date) the program is directed to box 42 where the report is compiled and all nonmonetary values with original dates up to and including the report date are updated to current date values. All monetary values with original dates up to and including the report date are updated only as from the report date to the current date. In that way it is always a report of the real financial position at a past date expressed at the current rate.

When a report is selected of values at any past date, the nonmonetary values with original dates up to and including the past date selected, are always updated to the current date and displayed and/or printed/processed/transferred always at the current date values—not at the past date values. This fact is very easy for people living in a hyperinflationary economy to understand. Absolutely no-one is interested in anything stated at yesterday's value when the cash inflation rate is 5 percent or 10 percent per day. People living in low inflation economies still find this hard to accept because of the very strong influence of the money illusion, namely the mistaken believe that depreciating money keeps its value over time in a low cash inflationary economy.

Because of the current difficulty of producing real time final financial statements an exception is only made for work on the completion of periodic reports of the financial position of an economic entity as at a specific date, for example month-end, quarter-end, six monthly accounts and year-end financial statements. When this work is done after the closing date, then values only for the purpose of finalising the closing reports, are run at the closing date rate. These closing reports are finalised at the closing date rate, but always presented after that date only with all monetary and nonmonetary values updated to the current date rate.

Displaying and printing the reports are detailed in the flowchart.

The year-end closing routine is selected at option 7 YE Closing Routine in box 2. The program proceeds to decision diamond 51 where it is directed to box 52. When the final YE closing of all income and expense accounts to zero and the transfer of closing Balance Sheet balances to the new year opening balances are requested at a date after the year-end date in the new financial year, all values with original dates up to and including the YE date are processed at the YE rate. Monetary values are not updated while all nonmonetary values up to and including the YE date are updated to the YE date.

Financial Results presented in the form of Operating Results, Profit and Loss Statement, Balances Sheet, etc, should where ever possible only be presented in electronic form to facilitate the updating to current values of all the values in these reports when they are presented at a date after the actual date of the statements. Copies printed on paper should preferably be destroyed whenever the CPI level changes and new ones should be printed at the current date values when necessary for consultation.

A financial statement of account is a snapshot of an economic entity's real financial position at a specific day of the financial year. Current period monetary values are presented in those financial statements as monetary values (not updated) only on that actual day. At any date after the actual date of the financial statements, monetary values are updated—only in the financial reports and not in the actual ledger accounts—the same as nonmonetary values because the financial statements then relate to the real financial position of the economic entity at a specific date—in the past. It is a snapshot of a static situation in the past.

A monetary value is never updated while it is a monetary value in the actual ledger account of an economic entity. The balance sheet is not a ledger account and there are no monetary values in the profit and loss account, of which the profit and loss statement is a direct copy. The net monetary loss or gain is transformed into a nonmonetary value the moment it is calculated and recorded in the accounts of an economic entity and has to be updated over time.

Prior period comparative values and normal budget values are all (monetary and nonmonetary values) updated to the current date rate and displayed and/or printed at current date values. Care must be taken to understand that monetary values at prior dates and as budget values are updated the same as nonmonetary values—only for comparison purposes—but never in an actual account situation.

A depreciating monetary value is a real value at a specific moment in time. The next moment or day it is a different real value for that moment or that day in time in a cash inflationary, cash hyperinflationary or cash deflationary economy, as applicable. It all depends on the level of accuracy required.

When a monetary value appearing in a pre-set budget prepared at a specific date or as a prior period figure is presented, displayed or printed at any time after the prior period date or after the date the original budget was prepared, it is the real value, which the monetary value represented at that prior period date or at the date the budget was originally prepared, that is updated for comparison purposes only.

The same applies to forecasts. Monetary values in forecasts are updated like nonmonetary values when a monetary value at a specific date is forecasted at another date when the real value of the original monetary value is forecasted to remain the same. The real value of the originally forecasted monetary value at the originally forecasted date is updated at the rate of the forecasted CPI at the future date.

In an embodiment of the invention, all nonmonetary values are always continuously updated in subsidiary ledgers, journals and books of account when accessed.

In an embodiment of the invention, all nonmonetary values of all modules of a completely integrated financial accounting and cost and management accounting system are always continuously updated over time when accessed.

In an embodiment of the invention all nonmonetary values are always continuously updated in all costing models, eg. standard costing, job costing, project costing, marginal costing, process costing, etc when accessed.

While specific embodiments of the invention have been disclosed, it will be appreciated by those skilled in the art that various modifications and alterations to those details could be developed in light of the overall teachings of the disclosure. Accordingly, the particular arrangements disclosed are meant to be illustrative only and not limiting as to the scope of the invention.

What is claimed is:

I A computerized accounting practice for an economic entity which is a method of providing accounting information, reports and statements which comprises:
the continuous daily computer updating (increasing or decreasing, as the case may be) of all nonmonetary values in an accounting practice to continuously maintain all said nonmonetary values at daily constant real economic values over time when accounting an economic entity's economic activity to prevent Historical Cost Accounting inflation, Historical Cost Accounting hyperinflation and Historical Cost Accounting deflation, as applicable, in all the said nonmonetary values for an unlimited period of time whenever accounting values are accessed;
providing for the entering in the computerized accounting system of the latest change (or actual level of the CPI, as applicable) in the CPI as soon as it is officially available;
providing for the loading of all opening balances with all nonmonetary values entered at updated real values and the loading of monetary values indicated as such;
providing for the entering of all subsequent accounting transactions at nonmonetary values continuously current at the date of the transaction and current monetary values at nominal monetary values at the date of the transaction and indicated as monetary values;
providing for always reading every value with its original date and an indication whether the value is a monetary value or not;
providing that all values are entered at their original dates and values;
providing that all values are entered as either monetary or nonmonetary values;
providing that all monetary values are displayed, printed and transferred at their nominal original values when actual monetary ledger account balances (eg. Bank Account) or actual monetary values are requested for current financial period purposes;
providing for the Net Monetary Gain or Loss report which is run at the year-end date before the YE Closing routine is run;
providing for a one-sided journal entry to be entered to record the Net Monetary Gain or Loss which becomes a nonmonetary value the moment it is accounted and has to be updated over time;
providing for the program to determine whether a report date requested is the same as the current date. When the answer is Yes the report is compiled and all nonmonetary values with original dates up to the current date are updated to the current date;
providing that when the program determines that the report date requested is not the same as the current date (i.e. it is a past date), the report is compiled and all nonmonetary values with original dates up to and including the report date are updated to current date values. All monetary values with original dates up to and including the report date are updated only as from the report date to the current date. In that way it is always a report of the real financial position at a past date expressed at the current rate;
providing that when a report is selected of values at any past date, the nonmonetary values with original dates up to and including the past date selected, are always updated to the current date and displayed and/or printed/processed/transferred always at the current date values—not at the past date values;
providing that due to the current difficulty of producing real time final financial statements an exception is only made for work on the completion of periodic reports of the financial position of an economic entity as at a specific date, for example month-end, quarter-end, six monthly accounts and year-end financial statements. When this work is done after the closing date, then values only for the purpose of finalising the closing reports, are run at the closing date rate. These closing reports are finalised at the closing date rate, but always presented after that date only with all monetary and nonmonetary values updated to the current date rate;
providing that when the final YE closing of all income and expense accounts to zero and the transfer of closing Balance Sheet balances to the new year opening balances are requested at a date after the year-end date in the new financial year, all values with original dates up to and including the YE date are processed at the YE rate. Monetary values are not updated while all nonmonetary values up to and including the YE date are updated to the YE date;
providing that current period monetary values are presented in those financial statements as monetary values (not updated) only on that actual day. At any date after the actual date of the financial statements, monetary values are updated—only in the financial reports and not in the actual ledger accounts—the same as nonmonetary values because the financial statements then relate to the real financial position of the economic entity at a specific date—in the past;
providing that prior period comparative values and normal budget values are all (monetary and nonmonetary values) updated to the current date rate and displayed and/or printed at current date values;
providing that monetary values in forecasts are updated like nonmonetary values when a monetary value at a specific date is forecasted at another date when the real value of the original monetary value is forecasted to remain the same. The real value of the originally forecasted monetary value at the originally forecasted date is updated at the rate of the forecasted CPI at the future date;
providing that all nonmonetary values are always continuously updated in subsidiary ledgers, journals and books of account when accessed;
providing that all nonmonetary values of all modules of a completely integrated financial accounting and cost and management accounting system are always continuously updated over time when accessed;
providing that all nonmonetary values are always continuously updated in all costing models, eg. standard costing, job costing, project costing, marginal costing, process costing, etc when accessed.
